(19) United States
(12) Patent Application Publication
(10) Pub. No.: US 2025/0156426 A1
(43) Pub. Date: May 15, 2025

(54) METADATA RECOMMENDATIONS GENERATION

(71) Applicant: American Express Travel Related Services Company, Inc., New York, NY (US)

(72) Inventors: Ashank GUPTA, New Delhi (IN); Vaibhav GUPTA, New Delhi (IN); Aditya Kumar MISHRA, Patna (IN); Vinay DHINGRA, Haryana (IN); Purvi SHAH, New York, NY (US); Ritesh SAHA, New Delhi (IN); Sanjeev Kumar YADAV, Haryana (IN); Anuj GUPTA, Gurgaon (IN)

(73) Assignee: American Express Travel Related Services Company, Inc., New York, NY (US)

(21) Appl. No.: 18/505,768

(22) Filed: Nov. 9, 2023

(51) Int. Cl. G06F 16/2457; G06F 16/242

(52) U.S. Cl. CPC G06F 16/24578; G06F 16/243

(57) ABSTRACT

Disclosed herein are system, method, and computer program product embodiments for generating metadata element recommendations. For example, the method includes acquiring, by at least one processor and via a user interface, metadata associated with a data store. The method also includes performing natural language processing on the metadata to generate processed metadata, generating a candidate table name and a table description associated with the candidate table name for a table included in the metadata, and generating a first candidate attribute name, an attribute description associated with the first candidate attribute name, and a corresponding data type for each attribute associated with the table. The method also includes generating a second candidate attribute name for each attribute by extracting one or more keywords from the first candidate attribute name, and modifying the user interface to include at least the candidate table name.

### TECHNICAL FIELD

Aspects relate to systems and methods for generating recommendations for standardization of metadata.

### BACKGROUND

Companies have vast amount of data. Data is an important asset for any firm. Teams are expected to measure the fitness or the quality of their data before further leveraging it in their crucial decision-making processes. For a relational database, metadata elements may include tables and attributes. One aspect of data integration includes naming the metadata elements. Names may be used for querying data and identifying personally identifiable information. The format of this data or the format of corresponding metadata, however, may not be standardized or uniform. This may lead to inefficiencies in computer processing when the data and/or metadata are used downstream for further processing. In addition, today, data is increasing in volume as well as velocity. A structured and concrete metadata management is desired.

### SUMMARY

Aspects of this disclosure are directed to systems and methods for generating metadata element recommendations. The method and system can acquire metadata associated with a data store via a user interface. Natural language processing on the metadata is performed to generate processed metadata. A candidate table name and a table description associated with the candidate table name for a table included in the metadata is generated. A first candidate attribute name, an attribute description associated with the first candidate attribute name, and a corresponding data type are generated for each attribute associated with the table. A second candidate attribute name for each attribute is generated by extracting one or more keywords from the first candidate attribute name. The user interface is modified to include at least the candidate table name.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1 is a block diagram of an environment for a system that provides metadata recommendation, in accordance with an embodiment of the present disclosure.

FIG. 2 is a diagram that shows a processing flow for the system, in accordance with an embodiment of the present disclosure.

FIG. 3 is a diagram that shows a processing flow for table name and attribute name generation, in accordance with an embodiment of the present disclosure.

FIG. 4 is a flow chart for a method for generating business metadata, in accordance with an embodiment of the present disclosure.

FIG. 5 is flow chart for a method for determining an attribute data type, in accordance with an embodiment of the present disclosure.

FIG. 6 is a flow chart for a method for identifying personally identification information, in accordance with an embodiment of the present disclosure.

FIG. 7A illustrates a user interface for data ingestion registration, in accordance with an embodiment of the present disclosure.

FIG. 7B illustrates a user interface for displaying register details, in accordance with an embodiment of the present disclosure.

FIG. 7C illustrates a user interface for displaying storage details, in accordance with an embodiment of the present disclosure.

FIG. 7D illustrates a user interface for displaying table information, in accordance with an embodiment of the present disclosure.

FIG. 7E illustrates a user interface for displaying a notification, in accordance with an embodiment of the present disclosure.

FIG. 7F illustrates a user interface for displaying the generated recommendations, in accordance with an embodiment of the present disclosure.

FIG. 8 is an example method for generating a metadata recommendation in accordance with an embodiment of the present disclosure.

FIG. 9 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Aspects of the present disclosure relate to a system for generating recommendations for schema associated with a data store. In particular, the present disclosure relates to generating recommendations based on metadata provided by a user for schema evenness. The generated recommendations can be provided during data onboarding.

Metadata may include information about data stored in the data store (e.g., a database). The information may include an origin of the data. Before creating and storing data in the data store, the metadata is registered and approved by a review team. The process of registering the metadata may include multiple iterations for the review team to approve. This may occur before the data can be ingested. The manual review and validation process, however, suffer from a plurality of problems including being time consuming, labor intensive, prone to human errors, and may lead to poor quality metadata. With the increasing volume of the data and desire for faster and/or less time-consuming data ingestion, a structured metadata management is desired.

What is needed is a platform that can provide standardized metadata recommendations and provide recommendations that adhere with guidelines desired for the intended platform at a table and attribute levels. A comprehensive metadata platform for identification and enhancement of ambiguous metadata is provided. The metadata platform described herein may be an enterprise-wide solution for standardization of metadata and optimization of a metadata onboarding journey. The approaches described herein may provide a comprehensive solution to obtain desired metadata quality. The approaches are used to recommend the technical as well as business metadata elements that are used downstream for further processing.

Business metadata (including a business name and/or description) may be provided by the user via a metadata registration portal as described further below. The business metadata may then be standardized. The standardized metadata may then be fed into a technical metadata recommendation module. The technical metadata recommendation module may utilize rule based processing and/or other natural language processing (NLP) based techniques to identify keywords to provide a technical table name and/or attribute names. These keywords may be recognized as important keywords and/or the most important keywords. Also, a clustering mechanism may be used for predicting the datatype and/or personally identifiable information tagging for a given input attribute.

The platform and associated models and methodologies described herein can enhance schema quality on any metadata onboarding platform and reduce the manual intervention by providing recommendations to metadata elements in real-time. For example, the platform may identify and enhance ambiguous metadata elements. The metadata elements may include a table name, a technical attribute name, an attribute datatype, a business attribute name, a business description, and personally identifiable information (PII) identifier (ID). The recommendations may be generated using artificial intelligence techniques including statistical and natural language processing techniques (e.g., yet another keyword extraction (YAKE)), centroid based clustering mechanism, term frequency and inverse document frequency (TF-IDF), gunning fog index, and certain business logic. The generated recommendations are standardized among multiple users.

The models, methods, and systems disclosed herein can be deployed on any platform as a model as a service (MaaS). For example, the model may be deployed on an enterprise cloud platform (eCP) and integrated with multiple data onboarding platforms.

### System Overview and Function

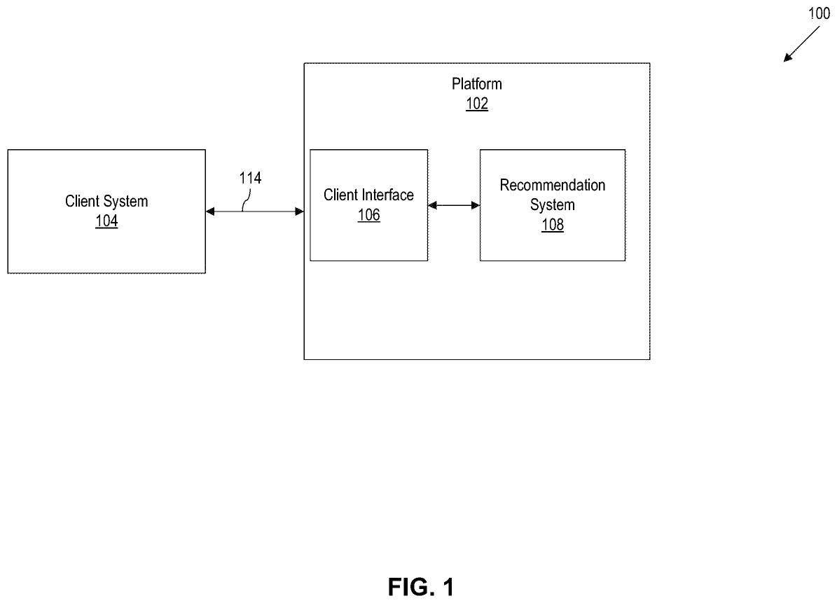

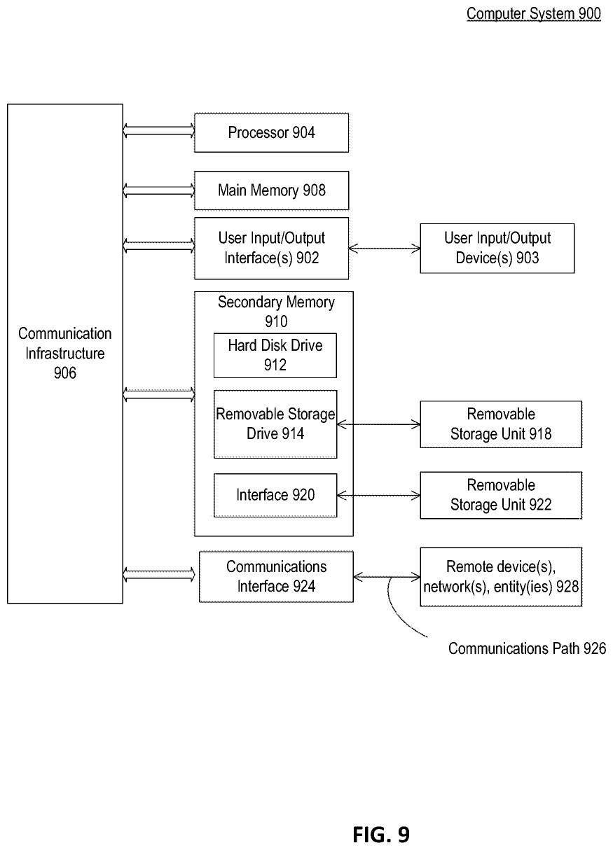

FIG. 1 is a block diagram of an environment 100 for a recommendation system 108 that provides metadata elements recommendation, in accordance with an embodiment of the present disclosure. Environment 100 may include a platform 102 and a client system 104. Platform 102 may include a client interface 106 and recommendation system 108. Platform 102 and recommendation system 108 may operate on one or more servers and/or databases. In some embodiments, platform 102 may be implemented using computer system 900 as described further with reference to FIG. 9. Platform 102 may provide a cluster computing platform or a cloud computing platform to generate metadata recommendations based on metadata provided by or acquired from client system 104. For example, platform 102 may receive metadata from client system 104. Recommendation system 108 may process the metadata and provide the recommendations via client interface 106.

Client system 104 may be a user device accessing platform 102 via a network 114. Client system 104 may be a workstation and/or user device used to access, communicate with, and/or manipulate platform 102. Client system 104 may access platform 102 using client interface 106.

Client interface 106 may be an interface for presenting and/or receiving information to/from a user. An interface may be a communication interface such as a command window, a web browser, a display, and/or any other type of interface. Other software, hardware, and/or interfaces may be used to provide communication between the user and platform 102. For example, client interface 106 may be a web portal that provides a web page or website to the user for viewing and interaction. The web portal may be located at a web address accessible via a web browser, and may be supported by one or more servers (e.g., computer system 900 as further described with reference to FIG. 9). The website may be a graphical user interface (GUI) provided by platform 102 and/or via an application programing interface (API) provided by platform 102.

As used herein, the API may comprise any software capable of performing an interaction between one or more software components as well as interacting with and/or accessing one or more data storage elements (e.g., server systems, databases, hard drives, and the like). An API may comprise a library that specifies routines, data structures, object classes, variables, and the like. Thus, an API may be formulated in a variety of ways and based upon a variety of specifications or standards, including, for example, POSIX, the MICROSOFT WINDOWS API @, a standard library such as C++, a JAVA API, and the like.

Network 114 refers to a telecommunications network, such as a wired or wireless network. Network 114 can span and represent a variety of networks and network topologies. For example, network 114 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in network 114. Cable, Ethernet, digital subscriber line (DSL), fiber optic lines, fiber to the home (FTTH), and plain old telephone service (POTS) are examples of wired communication that may be included in the network 114. Further, network 114 can traverse a number of topologies and distances. For example, network 114 can include a direct connection, personal area network (PAN), local area network (LAN), metropolitan area network (MAN), wide area network (WAN), or a combination thereof.

By interacting with the GUI using client system 104, the user may provide metadata to be approved. For example, client system 104 may upload to platform 102 a file comprising the metadata elements (e.g., a table name, an attribute name, a table description) during a metadata registration process. Recommendation system 108 may analyze the metadata elements provided by the user to generate one or more recommendations for the metadata elements. The one or more recommendations are presented to the user via client interface 106. A “recommendation” may include one or more text strings corresponding to suggested table and/or attribute names. These text strings may be identified and provided to a user based on the processes below.

Recommendation system 108 described above provides several advantages. First, metadata elements are unified, verified, and standardized using a single system. Second, recommendation system 108 provides the advantage of significant time saving for any metadata onboarding process (e.g., more than 8000 potential hours). In addition, the method described herein provides self-certification capability by automating the metadata certification process. The methods disclosed herein can be developed as a model as a service in such a way that it is easily scalable to other platforms without any substantial additional effort. Further, the generated metadata are highly accurate. In some aspects, the overall average accuracy is about 85% when comparing generated table names and attribute names with existing metadata. The process for generating these computational efficiencies is further described throughout this description.

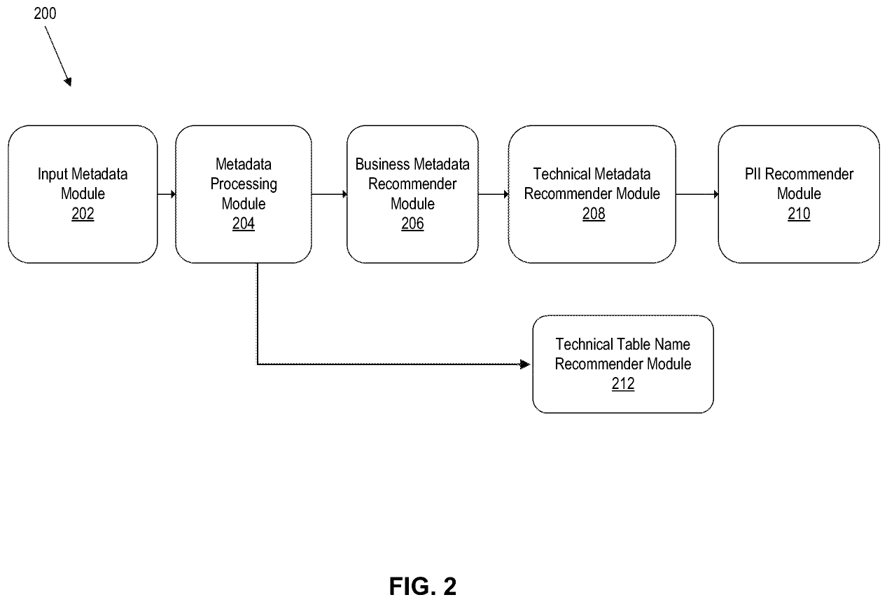

FIG. 2 is a diagram that shows a processing flow 200 for recommendation system 108, in accordance with an embodiment of the present disclosure. Recommendation system 108 may comprise an input metadata module 202, a metadata processing module 204, a business metadata recommender module 206, a technical metadata recommender module 208, a PII recommender module 210, and a technical table name recommender module 212.

Input metadata module 202 may receive the metadata provided by client system 104. For example, the user may upload an attribute name and a description of the attribute. For example, the user may enter as an attribute name “auth_sign_ad” and as the business name “authorized signer address.” The user may also provide as the associated business description “address of an account holder” and as attribute type string. The PII ID may be provided as “bd_pii_addr.” In some examples, the name and description provided by the user may include multiple acronyms, misspelled words, and may not be in a readable format.

Input metadata module 202 may perform a nullity check. For example, input metadata module 202 may check whether all the desired fields have been provided by the user. In response to determining that one or more of the desired fields are missing, recommendation system 108 may not generate recommendations, as the metadata and the metadata elements provided by the user is incomplete. Recommendation system 108 may generate a notification to the user indicating that the metadata is incomplete. In addition to the notification, recommendation system 108 may modify a user interface to include one or more fields for the user to input the missing metadata elements. For example, in response to determining that the metadata elements provided by the user do not include an attribute description, recommendation system 108 may modify the user interface to include a text input field for the user to enter the attribute description.

Metadata processing module 204 may process the uploaded metadata using natural language processing to generate processed metadata. For example, metadata processing module 204 may expand a provided name, identify and correct misspelled words, perform stemming, perform syntactic analysis, and the like. The processed metadata may be used by business metadata recommender module 206 and technical table name recommender module 212 to generate a recommended or candidate attribute name and/or description and a technical table name, respectively.

Business metadata recommender module 206 may generate a business attribute name and a business description associated with the business attribute name. To generate the business attribute name and the business description, business metadata recommender module 206 may clean and standardize a business name and an attribute description provided by the user during the metadata registration process. Business metadata recommender module 206 may detect and restrict a user from using any violations. For example, business metadata recommender module 206 may check whether the business description and the business name conform with predefined standards such as inclusive design language. In order to determine whether the provided name and description conform with a standard, business metadata recommender module 206 may compare keywords extracted from the provided name and description with a list that includes expressions and terms to be avoided. In some aspects, the business attribute name and the business description may correspond to the business name and description provided by the user when the business name and description conform with the standard.

Technical metadata recommender module 208 may generate a technical attribute name based on the business metadata elements. In addition, technical metadata recommender module 208 may predict a datatype for each attribute. In some aspects, technical metadata recommender module 208 may generate the technical attribute name based on the business attribute name and the business description. The business metadata attribute name and the business description may correspond to the name and description generated by business metadata recommend module 206. For example, for an attribute with the business name “country code,” the technical name may be “ctry_cd”. The technical name may be used in querying the data.

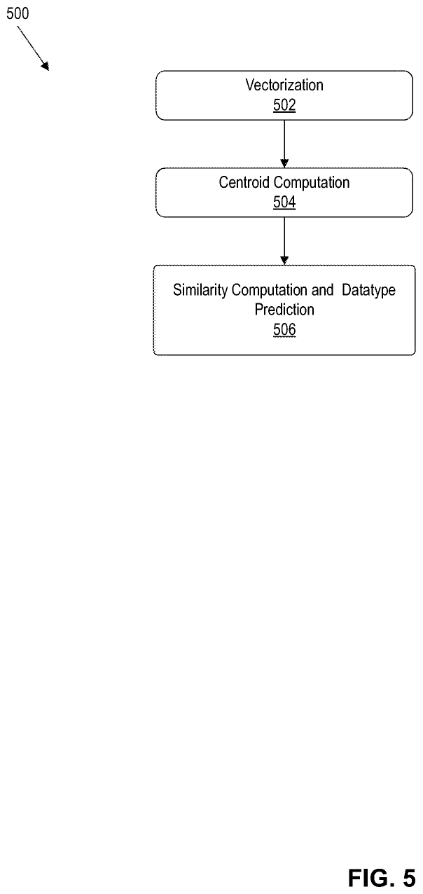

In addition to the technical name recommendation, technical metadata recommender module 208 may also identify a datatype for the attribute. For example, the datatype may include string, float, double, date, timestamp, integer, and the like. Datatype identification is further described with reference to FIG. 5.

Technical table name recommender module 212 may predict a technical table name based on business metadata elements provided by the user. The business metadata elements may include a name, a description, and a table type. The business metadata elements may be received from metadata processing module 204.

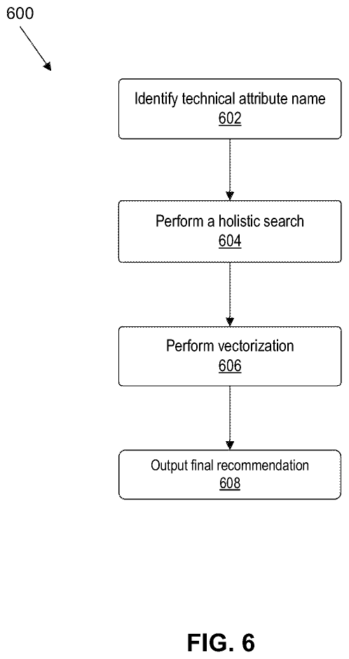

PII recommender module 210 may identify PII within the metadata. PII may refer to details that may potentially lead to the identification of an individual. PII may include an address, name, and card details. PII recommender module 210 may identify and tag potential metadata elements that include PII information. PII recommender module 210 may process the metadata using a plurality of layers. One or more layers of PII recommender module 210 may be based on a holistic search of the technical attribute metadata and comparisons with existing attribute metadata to identify matches and to predict the PII information if found. An additional layer may use a clustering methodology to create clusters for each PII ID. After creating clusters, a cosine similarity for the provided business metadata with the clusters is determined. The cosine similarity may be determined after performing vectorization. The determined cosine similarity may be compared with thresholds to predict and tag potential PII for a certain input. PII identification is further described in relation to FIG. 6.

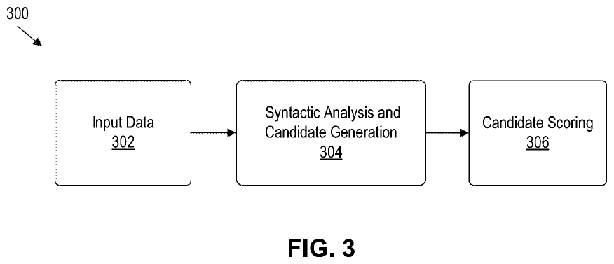

FIG. 3 a diagram that shows a processing flow 300 for table name and attribute name generation, in accordance with an embodiment of the present disclosure.

At 302, the text is input as described previously herein. For example, input data provided by client system 104 may include textual information.

At 304, syntactic analysis and candidate generation may be performed (e.g., by metadata processing module 204) on the textual information. Syntactic analysis may include stop-words removal, special characters removal, and string splitting at a special character. For example, the input data may be “Excel is an amazing tool for data science. But a lot of data science professionals do not like Excel.” After syntactic analysis, the data may be transformed to “Excel amazing tool data science, data science professionals like Excel.” The processed data may represent candidates for name generation. In addition, prefixing/suffixing is performed to generate additional candidates.

At 306, candidate score of the processed data may be used to generate a body of a name. The body of the name is generated by utilizing business logic (cleaning the business name provided) and applying a keyword extraction algorithm. For example, a YAKE algorithm may be implemented. The body of the name may be standardized by expanding acronyms, checking syllable and characters length, and incorporating uniqueness and inclusion diversity checks. The standardized name may correspond to the recommended table name and the recommended attribute name for the provided metadata. In some aspects, recommendation system 108 may generate one or more recommended table names and one or more recommended attribute names.

The keyword extraction algorithm may rely on statistical text features extracted from individual documents to identify keywords in that text. These keywords may be deemed important and/or the most important keywords from the text. The keyword extraction algorithm may be based on a set of features that capture keyword characteristics. In some embodiments, the keyword extraction algorithm may include determining a score for each candidate keyword (e.g., each extracted keyword from the attribute description). A score or a metric may be associated with each of the features. The scores may be combined to assign a single score to each keyword. The lower the score, the more relevant the keyword is. The set of features may include casing, word position, word frequency, word context relatedness, and word different sentence. Casing may refer to capitalized words and acronyms. Capitalized words and acronyms may be given a higher importance. For example, a lower score may be assigned to capitalized words and acronyms. A lower score may be assigned to words that are at the beginning of the document or at the beginning of the input text. The word frequency of each word may be calculated. A score may be assigned to each word based on the word frequency. A lower score may be assigned to frequent word. A word context relatedness score may quantify how related a word is to its context. Word different sentence quantify how often a candidate word occurs in different sentences. The scores are calculated and combined to give a final score to individual keyword. As discussed above, a lower score may indicate a higher importance. In some aspects, the score for each keyword may be calculated using:

$$score ( w ) = \frac{d \times b}{a + \frac{c}{d} + \frac{e}{d}} \qquad ( 1 )$$

where a is a metric associated with casing, b is a metric associated with word position, c is a metric associated with word frequency, dis a metric associated with word context relatedness, and e is a metric associated with word different sentences.

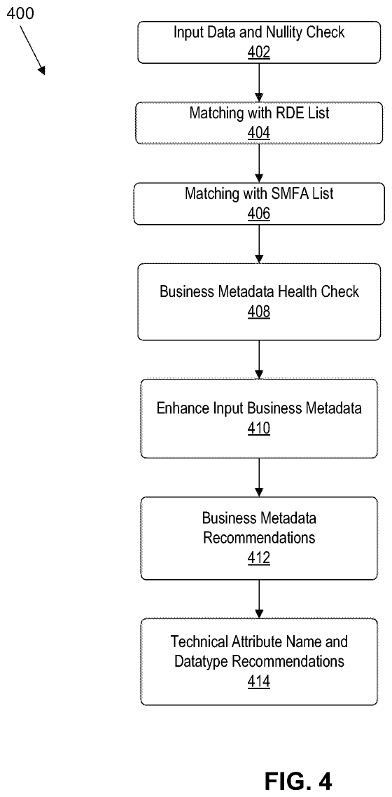

FIG. 4 is a flow chart for a method 400 for generating business metadata, in accordance with an embodiment of the present disclosure. Method 400 may be implemented by business metadata recommender module 206.

At 402, recommendation system 108 may perform a nullity check. Recommendation system 108 may analyze metadata provided by the user to determine whether the input data are incomplete. In response to determining that the input data are not complete, recommendation system 108 may generate a message to the user indicating that the input data are not complete and no recommendations are generated. This prevents users from providing partial or incomplete metadata.

At 404, recommendation system 108 may compare a business attribute name provided in the input data with attribute names in a rationalized data element (RDE) list. The RDE list may include standardized business attributes names and description associated with the business attribute name. The RDE list may include a list of predefined attributes such as a credit card number. The description of the credit card number is desired to be standardized and common between different data stores created by different users. The RDE may be created by a user, an administrator, or a member of a review team. The RDE may be uploaded to platform 102 via client interface 106. In addition or alternatively, the RDE list may be input to the client interface 106. The RDE list may be created by a leveraging algorithm such as a genetic algorithm (GA) to extract quality metadata elements from the data store of metadata. High quality metadata may be used to train business metadata recommender module 208. High quality metadata elements may correspond to metadata elements previously approved by the review team.

In response to determining that there is a match, the recommended business attribute name is the business attribute name provided by the user. In response to determining that there is no match, the process may proceed to 406.

At 406, recommendation system 108 may compare the business attribute name provided by the user with a standardized most frequent attributes (SMFA) list. The SMFA list may include attributes with standardized business names and respective description created by recommendation system 108. For example, the SMFA list may include a list of most common attributes used in a particular environment and/or in a particular organization or company. Recommendation system 108 may track attributes and may add the attributes to the list. In some aspects, the attributes in the SMFA list may be standardized before storing them in the SMFA list. In response to determining that there is a match, the system outputs the recommendation and the process flow proceeds to 408. In response to determining that there is no match, the process proceeds to 408.

At 408, recommendation system 108 may perform a metadata health check. The metadata health check may include determining a text readability metric (e.g., gunning fog index (GFI) score). The gunning fog score may be indicative of how simple it is to read and to understand a written statement (e.g., the business attribute description). In one example, a GFI score of 6 indicates that a text is easy to read. A GFI score greater than 17 indicates that the text is very difficult to read and interpret. If the metadata element (e.g., the business attribute name) provided by the user or matched by the SMFA list has a score greater than 17 or the business metadata has multiple misspelled words, then the metadata element will be modified. The process proceeds to 410.

At 410, system may enhance input business metadata and recalculate the GFI score. Recommendation system 108 may apply one or more techniques to enhance the business metadata. For example, recommendation system 108 may expand acronyms, remove special characters, remove numerals, correct misspellings, word splitting, convert to title case, and resolve other irregularities for the business attribute name. For the business description, recommendation system 108 may perform an abbreviation check, correct misspelling, split words, perform punctuations check, and/or resolve other irregularities.

At 412, business metadata recommendations may be identified and output. The recommendation may correspond to the attribute matched with RDE, the attribute matched with SMFA, or the attribute name and description provided by the user. In some aspects, when the attribute is a match with the SMFA the system may generate one or more recommendations. If the GFI score for the business name and the business description is less than or equal to a first threshold (e.g., GFI less or equal to 16), the enhanced input recommendation is output.

If the GFI score for the business name is greater than a second threshold (e.g., greater than 17) and the GFI score for the business description is less than the first threshold (e.g., less or equal to 16), then the YAKE algorithm may be applied to generate the business name from the business description. If the GFI for the business name and the business description are greater than the second threshold, then no recommendations are generated. For example, a notification may be output on the user interface that indicates that the provided name and/or description are unsuitable for generating recommendations. Recommendation system 108 may provide the user with a user interface to input alternative business name and/or description.

At 414, the generated recommendation may be used for technical attribute name and datatype recommendations generation. The generated recommendation may be output to technical metadata recommender module 208.

FIG. 5 is flow chart for a method 500 for determining an attribute datatype, in accordance with an embodiment of the present disclosure. Method 500 may be implemented by technical metadata recommender module 208.

At 502, recommendation system 108 may apply a vectorization process on the textual data associated with the attribute name and the attribute description. The vectorization process converts text data to numerical vectors (e.g., vectors of real numbers). For each attribute, the textual data is converted into vectors by leveraging a vectorization technique (e.g., FastText, Word2Vec, global vectors for word representation, continuous bag of words, centroid based similarity mechanism such as TF-IDFand Cosine Similarity). In some aspects, recommendation system 108 may apply TF-IDF to generate a TF-IDF matrix. Table 1 shows an example TF-IDF matrix.

TABLE 1
TF-IDF matrix

| Attribute | International | Count | Transaction |
|---|---|---|---|
| 1 | 0.19476 | 0.0224 | 0.4569 |
| 2 | — | 0.8124 | 0.3124 |
| 3 | 0.6512 | — | 0.4122 |

At 504, recommendation system 108 may determine a centroid for each datatype. The centroid for each datatype may be obtained by training on existing metadata attribute details. In some aspects, datatype may include string, double, date, timestamp, int, bigint, smallint, and tinyint. The centroids for each datatype may be determined based on a sparse matrix. In some aspects, the centroids may be determined using:

$$C = \{ \frac{( x 1 + x 2 + … + x n )}{n} , \frac{( y 1 + y 2 + … yn )}{n} , … \} \qquad ( 2 )$$

where n is the number of keywords. At 506, recommendation system 108 may perform a similarity computation. Based on the similarity computation, recommendation system 108 may predict a datatype. In some aspects, recommendation system 108 may determine a cosine similarity with individual centroids. After determining the cosine similarity, recommendation system 108 may identify the datatype with the highest cosine similarity. Recommendation system 108 may select the datatype with the highest as the recommended datatype for the attribute. For example, for the following cosine similarities{‘bigint’:0.234, ‘date’:0.025, ‘double″’0.138, ‘int’:0.222, ‘smallint’:0.179, ‘string’:0.093, ‘timestamp’:0.020, ‘tinyint’:0.093}, bigint is selected as the recommended datatype.

FIG. 6 is a flowchart for a method 600 for attribute PII identification, in accordance with an embodiment of the present disclosure. Method 600 may be implemented by PII recommender module 210

At 602, recommendation system 108 may identify the technical attribute name with their respective PII identification. For example, card member name may be identified as pii_name. Card Member Address may be identified as pii_address.

At 604, recommendation system 108 may perform a holistic search matching on technical attribute names. The technical name may be matched with attributes previously identified as PII. Recommendation system 108 may apply techniques described previously herein on the provided technical name before the matching process (e.g., cleaning, permutation and combination, next generation data mining). For example, a user may provide “card_acct_no_other”. The provided technical attribute may be transformed to “Card Account Number” and matched with “acct_card_no.”

At 606, recommendation system 108 may perform vectorization via TF-IDF. A similarity metric (e.g., cosine similarity) is determined for each user provided input with PII clusters.

At 608, recommendation system 108 may identify the maximum similarity and determine whether the similarity satisfies a criteria (e.g., greater than a threshold). In response to determining that the cosine similarity satisfies the criteria, the respective attribute is tagged and identified as PII.

As discussed above PII ID clusters may be formed and used by recommendation system 108 for comparison with the provided metadata. High quality metadata are used to form the clusters (e.g., metadata that was previously approved by a review team). In addition, recommendation system 108 may generate and add dummy records of PII ID description to a cluster of PII ID.

### Example User Interfaces

Recommendation system 108 may be integrated seamlessly with data onboarding platforms with minimal effort. For instance, recommendation system 108 may be implemented on an in-house data platform. The platform may be an enterprise big data ecosystem. The platform may receive data from multiple sources. The platform may be used to generate market insights, powering innovation, driving the speed to market, and enabling cost efficiencies. Recommendation system 108 maintains the desired metadata quality through valuable recommendations for the technical and business metadata elements. Data is ingested from internal and external source systems into the platform and then organized to facilitate analytics and use case requirements.

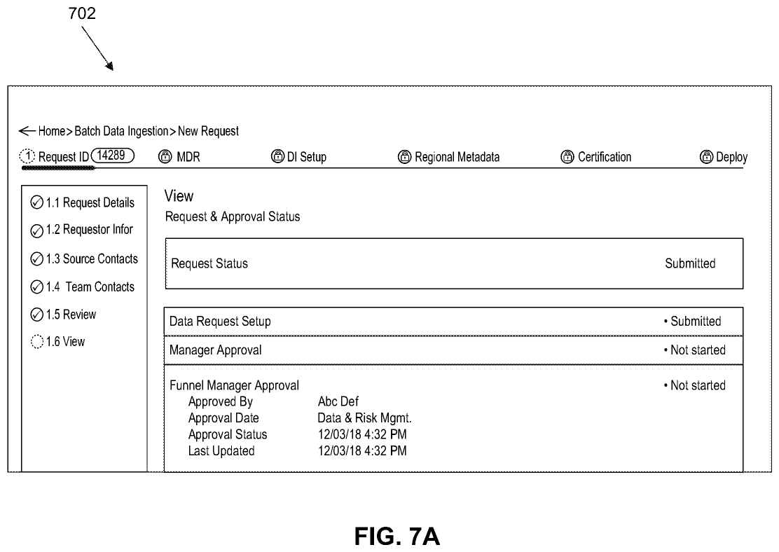

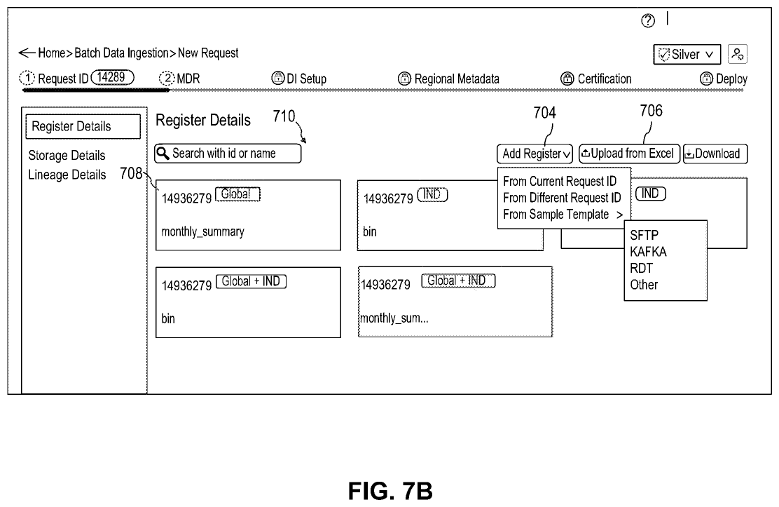

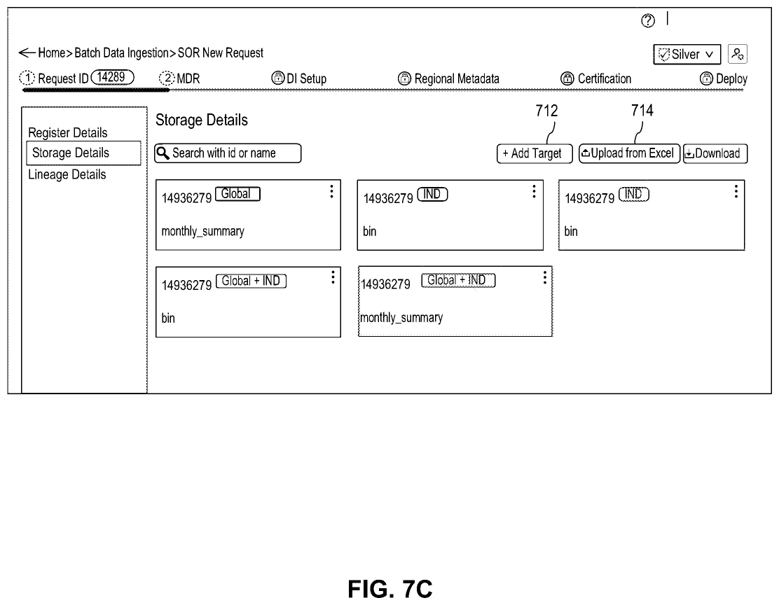

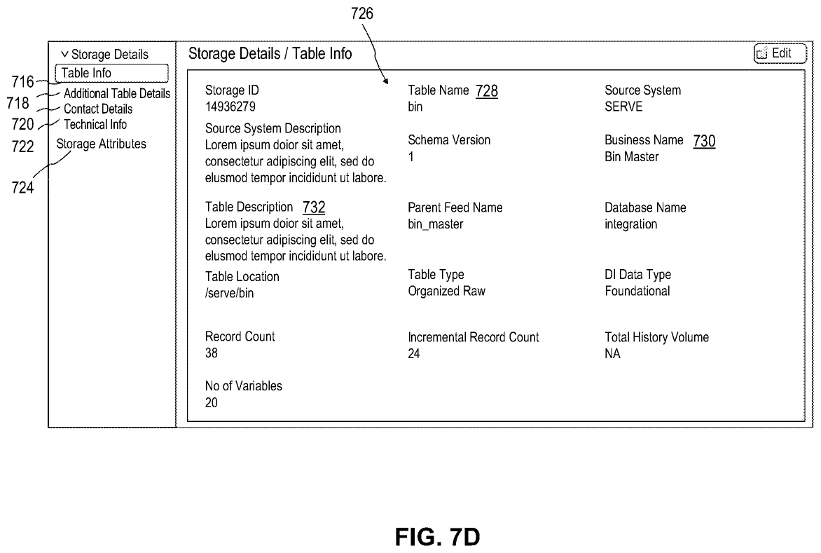

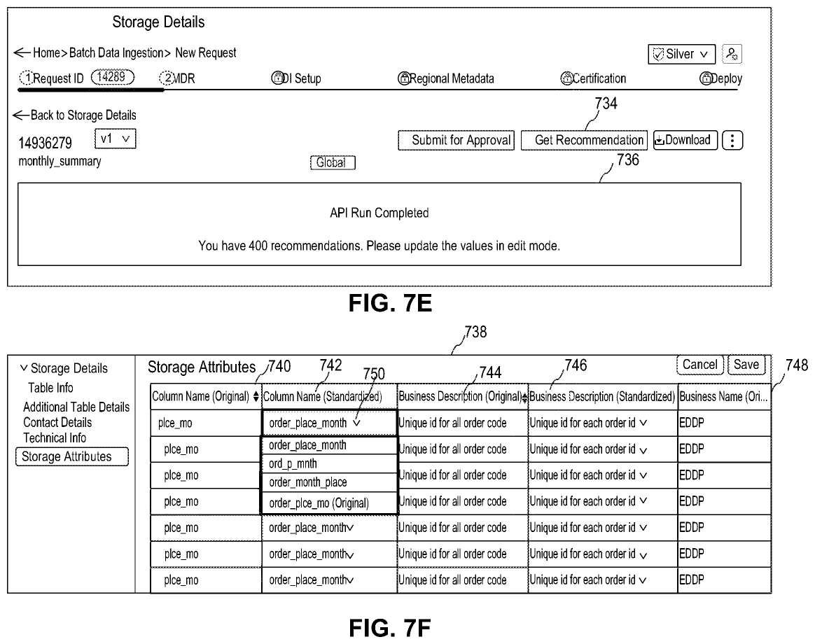

FIGS. 7A-7F illustrate exemplary user interfaces for recommendation system 108, in accordance with an embodiment of the present disclosure. Graphical user interfaces shown in FIGS. 7A-7F are part of recommendation system 108 and configured to allow a user to interact with recommendation system 108. FIG. 7A illustrates a user interface for data ingestion registration, in accordance with an embodiment of the present disclosure. FIG. 7B illustrates a user interface for displaying register details, in accordance with an embodiment of the present disclosure. FIG. 7C illustrates a user interface for displaying storage details, in accordance with an embodiment of the present disclosure. FIG. 7D illustrates a user interface for displaying table information, in accordance with an embodiment of the present disclosure. FIG. 7E illustrates a user interface for displaying a notification, in accordance with an embodiment of the present disclosure. FIG. 7F illustrates a user interface for displaying the generated recommendations, in accordance with an embodiment of the present disclosure.

The following example illustrates how the techniques described herein can be used during metadata registration. A user may complete the data ingestion registration on a portal of the platform.

A user may access a landing page for data ingestion registration. The user is provided with one or more GUI objects to upload details associated with a request to register the metadata, a requestor, a review team, and the like. A user interface 702 shown in FIG. 7A may show a submission summary. To upload the metadata, the user is provided with a first GUI object 704 to add the registration details manually and a second GUI object 706 to upload a file including the registration details. Upon uploading the metadata associated with a source of the data, a card is created displaying a unique register identification 708, signifying the successful initiation of the metadata registration journey. A pane 710 shows the uploaded register details.

Upon completion and review of the register details shown in pane 710, the subsequent step in the metadata registration process is the upload of storage details. The user may be provided with a “add target” GUI object 712 to upload the storage details manually or “upload from Excel” GUI object 714 to upload a file that includes the storage details. The storage details includes the metadata for one or more tables corresponding to the unique register identification 708.

After successfully uploading the metadata, the metadata may be presented in an editable format, allowing for any desired modifications. The user may also save the metadata to continue working on it later. For example, the user may be presented with additional navigational GUI object to review the storage details. The user may be presented with a GUI object 716 (shown in FIG. 7F) to display table information, a GUI object 718 to display additional table details, a GUI object 720 to display contact details, a GUI object 722 to display technical information, a GUI object 724 to display storage attributes. Upon activation of GUI object 718, the user is presented with a pane 726. Pane 726 may show a technical table name 728, a business table name 730, and a table description 732.

After reviewing the table information, the additional table details, the contact details, the technical information, the storage attributes, and making any desired changes, the user may select a “get recommendation” GUI object 734 (shown in FIG. 7E) to trigger recommendation system 108 to generate the recommendations. Upon selecting the “get recommendation” GUI object 734, recommendation system 108 may modify the user interface to display a notification that indicates that recommendation system 108 is running. For example, user interface may display “API is running for recommendations.” In some aspects, the notification may also display an estimated running time.

The user may be prevented from modifying the metadata while recommendation system 108 is in the process of generating recommendations. Once the model run has completed generating the recommendations, the user may be notified via email and provided with the recommendations, along with the ability to edit and view the values. In some aspects, a notification 736 may be output to the user interface indicating the number of recommendation generated. In addition, the user may be provided with pane 738 (shown in FIG. 7F) that shows the generated recommendations.

Pane 738 may display the generated recommendations. For example, a technical attribute name 740 (as provided by the user), a technical attribute name 742 (generated), an attribute description 744 (as provided by the user), an attribute description 746 (generated), and a business 748 name (original) may be displayed. An edit GUI object (not shown) may be presented to the user for modifying a recommendation. In some aspects, two or more recommendations may be generated. The user may be presented with a drop-down GUI object 750. Upon selecting drop-down GUI object 750, the user may be presented with additional recommendations.

### Methods of Operation

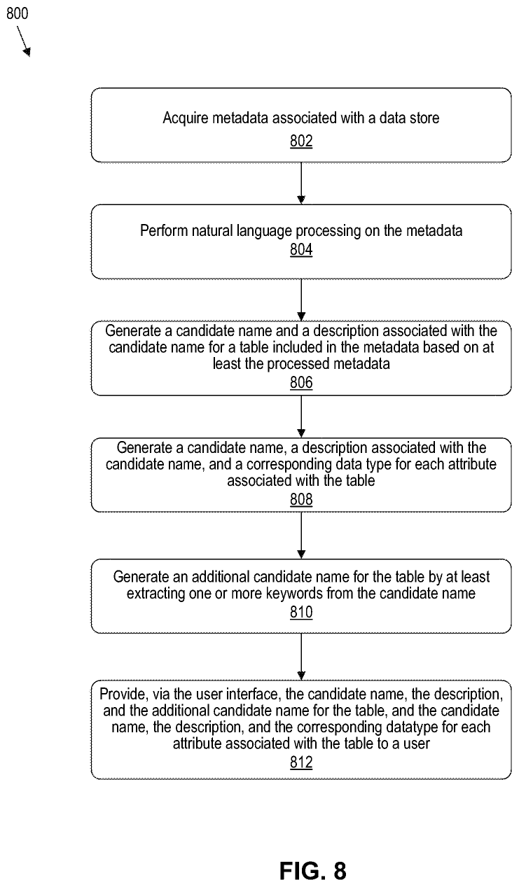

FIG. 8 is an example method 800 of operating platform 102 for generating metadata element recommendations, in accordance with an embodiment of the present disclosure.

Method 800 may be performed as a series of steps by a computing unit such as a processor. For example, method 800 may be implemented by recommendation system 108 and/or computer system 900 of FIG. 9.

At 802, recommendation system 108 may acquire metadata associated with a data store via a user interface. For example, a user may upload metadata via client interface 106.

At 804, recommendation system 108 may perform natural language processing on the metadata to generate processed metadata.

At 806, recommendation system 108 may generate a candidate table name and a table description associated with the candidate table name for a table included in the metadata based on at least the processed metadata.

At 808, recommendation system 108 may generate a first candidate attribute name, an attribute description associated with the first candidate attribute name, and a corresponding data type for each attribute associated with the table. The first candidate attribute name may correspond to the business attribute name generated by recommendation system 108.

At 810, recommendation system 108 may generate a second candidate attribute name for each attribute by extracting one or more keywords from the first candidate attribute name, wherein the second candidate attribute name corresponds to a technical name of the attribute.

At 812, recommendation system 108 may modify the user interface to include (i) the candidate table name, (ii) the table description, and (iii) the first candidate attribute name, the second candidate attribute name, the attribute description, and the corresponding datatype for each attribute associated with the table.

### Components of the System

Various embodiments may be implemented, for example, using one or more well-known computer systems, such as computer system 900 shown in FIG. 9. One or more computer systems 900 may be used, for example, to implement any of the embodiments discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

The terms “module” or “unit” referred to in this disclosure can include software, hardware, or a combination thereof in an aspect of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

The above detailed description and aspects of the disclosed recommendation system 108 are not intended to be exhaustive or to limit the disclosed recommendation system 108 to the precise form disclosed above. While specific examples for recommendation system 108 are described above for illustrative purposes, various equivalent modifications are possible within the scope of the disclosed recommendation system 108, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting method 800 and recommendation system 108 are cost-effective, highly versatile, and accurate, and may be implemented by adapting components for ready, efficient, and economical manufacturing, application, and utilization. Another important aspect of aspects of the present disclosure is that it valuably supports and services the historical trend of reducing costs, simplifying systems, and/or increasing performance.

These and other valuable aspects of the present disclosure consequently further the state of the technology to at least the next level. While the disclosed aspects have been described as the best mode of implementing recommendation system 108, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

The following aspects are described in sufficient detail to enable those skilled in the art to make and use the disclosure. It is to be understood that other aspects are evident based on the present disclosure, and that system, process, or mechanical changes may be made without departing from the scope of an aspect of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the system may be operated in any orientation.

Certain aspects have other steps or elements in addition to or in place of those mentioned. The steps or elements will become apparent to those skilled in the art from a reading of the following detailed description when taken with reference to the accompanying drawings.

What is claimed is:

1. A computer implemented method, comprising:
acquiring, by at least one processor and via a user interface, metadata associated with a data store;
performing, by the at least one processor, natural language processing on the metadata to generate processed metadata;
generating, by the at least one processor, a candidate table name and a table description associated with the candidate table name for a table included in the metadata based on at least the processed metadata;
generating, by the at least one processor, a first candidate attribute name, an attribute description associated with the first candidate attribute name, and a corresponding data type for each attribute associated with the table;
generating, by the at least one processor, a second candidate attribute name for each attribute by extracting one or more keywords from the first candidate attribute name, wherein the second candidate attribute name corresponds to a technical name; and
modifying, by the at least one processor, the user interface to include the first candidate attribute name, the second candidate attribute name, and the attribute description for each attribute associated with the table.

2. The method of claim 1, further comprising:
identifying personally identifiable information in attributes included in the metadata; and
tagging an attribute corresponding to the identified personally identifiable information.

3. The method of claim 2, wherein identifying the personally identifiable information comprises:
matching the attribute name with a list of technical attribute names.

4. The method of claim 1, wherein the candidate table name is a first candidate table name;
and wherein the method further comprises:
generating a second candidate table name based on one or more of a table type, a table description, and the first candidate table name.

5. The method of claim 4, wherein generating the second candidate table name further comprises:
generating a body of the name for the table by applying a keyword extracting algorithm; and
standardizing the body of the name to generate the second candidate table name by performing one or more operations, wherein the operations include expanding acronyms, checking syllable length, checking character length, and incorporating a uniqueness and inclusion diversity check.

6. The method of claim 5, wherein applying the keyword extracting algorithm comprises:
assigning a score for each keyword in the metadata; and
determining the additional candidate name by identifying one or more keywords based on the score.

7. The method of claim 1, wherein the metadata comprises at least an attribute name and an attribute description; and wherein generating the first candidate attribute name for each attribute comprises:
comparing the attribute name with one or more attributes names included in a frequent attribute list; and
in response to determining that there is no match between the attribute name and the one or more attributes, refining the attribute name to generate the first candidate attribute name.

8. The method of claim 1, further comprising:
converting textual data for an attribute of the metadata into vectors by determining a relevancy score;
determining a similarity score between the vectors and a centroid associated with a data type; and
identifying the data type for the attribute based on the similarity score.

9. The method of claim 1, further comprising:
providing the user interface for acquiring the metadata from the user;
displaying the acquired metadata; and
receiving one or modifications to the metadata from the user via the user interface.

10. The method of claim 1, further comprising:
determining a readability score for the candidate name of the table.

11. The method of claim 1, wherein generating the second candidate attribute name is based on the first candidate attribute name and the attribute description by extracting and ranking one or more keywords from the first candidate attribute name and the attribute description.

12. A system, comprising:
a memory; and
at least one processor coupled to the memory and configured to:
acquire, via a user interface, metadata associated with a data store;
perform natural language processing on the metadata to generate processed metadata;
generate a candidate table name and a table description associated with the candidate table name for a table included in the metadata based on at least the processed metadata;
generate a first candidate attribute name, an attribute description associated with the first candidate name, and a corresponding data type for each attribute associated with the table;
generate a second candidate attribute name for each attribute by extracting one or more keywords from the first candidate attribute name, wherein the second candidate attribute name corresponds to a technical name; and
modify the user interface to include the first candidate attribute name, the second attribute candidate name, and the attribute description for each attribute associated with the table.

13. The system of claim 12, wherein the at least one processor is further configured to:
identify personally identifiable information in attributes included in the metadata; and
tag an attribute corresponding to the identified personally identifiable information.

14. The system of claim 13, wherein the at least one processor is further configured to:
match the attribute name with a list of technical attribute names.

15. The system of claim 12, wherein the candidate table name is a first candidate table name;
and wherein the at least one processor is further configured to:
generate a second candidate table name for the table based on one or more of a table type, a table description, and the first candidate table name.

16. The system of claim 15, wherein the at least one processor is further configured to:
generate a body of the name for the table by applying a keyword extracting algorithm; and
standardize the body of the name to generate the second candidate table name by performing one or more operations, wherein the operations includes expanding acronyms, checking syllable length, checking character length, and incorporating a uniqueness and inclusion diversity check.

17. The system of claim 12, wherein the metadata comprises at least an attribute name and an attribute description; and wherein the at least one processor is further configured to:
compare the attribute name with one or more attributes included in a frequent attribute list; and
in response to determining that there is no match between the attribute name and the one or more attributes, refine the attribute name.

18. The system of claim 12, wherein the at least one processor is further configured to:
convert textual data for an attribute of the metadata into vectors by determining a relevancy score;
determine a similarity score between the vectors and a centroid associated with a data type; and
identify the data type for the attribute based on the similarity score.

19. A non-transitory computer-readable device having instructions stored thereon that, when executed by at least one computing device, cause the at least one computing device to perform operations comprising:
acquiring, via a user interface, metadata associated with a data store;
performing natural language processing on the metadata to generate processed metadata;
generating a candidate table name and a table description associated with the candidate table name for a table included in the metadata based on at least the processed metadata;
generating a first candidate attribute name, an attribute description associated with the first candidate attribute name, and a corresponding data type for each attribute associated with the table;
generating an second candidate attribute name by extracting one or more keywords from the first candidate attribute name, wherein the second candidate attribute name corresponds to a technical name; and
modifying the user interface to include the first candidate attribute name, the second candidate attribute name, and the attribute description for each attribute associated with the table.

20. The non-transitory computer-readable device of claim 19, the operations further comprising:
identifying personally identifiable information in attributes included in the metadata; and
tagging an attribute corresponding to the identified personally identifiable information.
